(19) United States
(12) Patent Application Publication
(10) Pub. No.: US 2006/0276251 A1
(43) Pub. Date: Dec. 7, 2006

(54) ROLLED PAPER DRIVE SHAFT DAMPER AND METHOD OF MAKING THE SAME

(75) Inventors: Peter T. Tkacik, Fort Mill, SC (US); Gordon Kane, Whitby (CA)

Correspondence Address: SUMMA, ALLAN & ADDITON, P.A., 11610 NORTH COMMUNITY HOUSE ROAD, SUITE 200, CHARLOTTE, NC, 28277, US

(73) Assignee: Caraustar Industries, Inc.

(21) Appl. No.: 11/422,660

(22) Filed: Jun. 7, 2006

Related U.S. Application Data
(60) Provisional application No. 60/688,054, filed on Jun. 7, 2005.

(51) Int. Cl. F16C 3/00

(52) U.S. Cl. 464/180

(57) ABSTRACT

The invention is a rolled paper drive shaft damper formed from a one-piece drive shaft damper blank. The invention also includes methods of making rolled paper drive shaft dampers.

### CROSS-REFERENCE TO PRIORITY APPLICATIONS

This application hereby claims the benefit of and incorporates entirely by reference commonly assigned provisional patent application Ser. No. 60/688,054, for Rolled Paper Drive Shaft Damper and Method of Making the Same, filed Jun. 7, 2005.

This application further incorporates entirely by reference commonly assigned U.S. non-provisional patent application Ser. No. 11/422,631, for Drive Shaft Damper Blank, filed concurrently Jun. 7, 2006, and commonly assigned U.S. non-provisional patent application Ser. No. 11/______, for Dampened Hollow Drive Shaft and Method of Making the Same, filed concurrently Jun. 7, 2006.

### FIELD OF THE INVENTION

The invention relates to a tubular drive shaft damper adapted to be inserted into a hollow automotive drive shaft to dampen vibrations and attenuate sound in, for example, cars, trucks, tractors, and heavy machinery. The invention further relates to a method of forming such a damper.

### BACKGROUND OF THE INVENTION

An automobile conventionally employs a hollow, tubular drive shaft to transmit torque from the transmission to the differential gears. In this regard, it is common for such drive shafts to vibrate and produce loud and annoying NVH (i.e., noise, vibration, and harshness). Accordingly, it is desirable to dampen NVH to provide for a quieter and smoother ride. Furthermore, it is desirable to prevent vibration to avoid mechanical failure from the loosening of assembled vehicle parts.

Previously, this problem was addressed by sliding a liner into the hollow drive shaft from one end. The liner is typically made of materials that dampen vibrations and attenuate noise.

For example, U.S. Pat. No. 4,909,361 to Stark et al. discloses a drive shaft damper having a base tube or core formed of helically wound paper. A helical retaining strip is fixed to the core and engages the bore of the drive shaft.

Another example is U.S. Pat. No. 5,976,021 to Stark et al. U.S. Pat. No. 5,976,021 discloses a drive shaft damper similar to that disclosed in U.S. Pat. No. 4,909,361. The difference between the two patent disclosures is that the core of the drive shaft damper disclosed in U.S. Pat. No. 5,976,021 has an innermost layer of waterproof material, such as aluminum foil.

Yet another example is U.S. Pat. No. 5,924,531 to Stark et al. U.S. Pat. No. 5,924,531 discloses a vibration damping shaft liner having a cylindrical core and a corrugated layer wound around the core in alternating helical grooves and flutes.

The drive shaft dampers of the above-referenced patents are well suited for their intended purpose. A problem that exists with these dampers, however, is the requirement that the dampers be inserted into the tubular drive shaft before the shaft has completed the manufacturing process. For example, the drive shaft damper may be inserted into the shaft after the shaft is formed, but before the ends of the shaft are welded on. In some cases, days or even weeks may pass from the time the liner is inserted until the tube ends are affixed. During this time, temperature and humidity fluctuations may adversely affect the liner, diminishing its NVH-reducing capability and perhaps causing it to fall out of the drive shaft.

Another problem with inserting the dampers before finishing the drive shaft manufacturing process is that the dampers may be damaged during the drive shaft finishing process. Finishing the drive shafts includes chamfering the tube ends, cleaning the shafts with fluids to prepare the drive shaft ends for reduction, and welding a reduced diameter portion to the drive shaft ends.

Drive shaft manufacturers reduce the drive shaft end diameter in part to decrease the materials and manufacturing required for adjacent parts, such as universal joints. The drive shaft dampers of the above-referenced patents, however, are not appreciably compressible to allow introduction through a smaller diameter opening and thereafter expand to conform to the larger diameter of the drive shaft bore.

Drive shaft manufacturers would prefer to insert the drive shaft damper after the drive shaft manufacturing process. In this regard, the above-referenced patents fail to address the problem of inserting a paper damper having a rigid core into a tubular reduced end diameter drive shaft.

To this end, U.S. Pat. No. 5,868,627 to Stark et al., is adaptable for placement in a reduced end diameter (i.e., double-swaged) shaft. The spiral wound expandable drive shaft damper of U.S. Pat. No. 5,868,627 contracts axially as it expands radially to fit the bore of the drive shaft. This facet of the damper disclosed in U.S. Pat. No. 5,868,627 may sacrifice damping ability upon fitment of the damper within the bore.

All of the above-referenced patents are commonly owned and incorporated by reference herein.

Furthermore, all of the dampers disclosed in the above-referenced patents are constructed using separate plies of paper. This practice may be wasteful in light of the present invention.

Therefore, a need exists for a drive shaft damper that minimizes or prevents NVH and that further conserves the resources required for its construction.

A further need exists for a drive shaft damper that is adapted for insertion into a double-swaged drive shaft yet does not forfeit axial coverage upon radial expansion.

### SUMMARY OF THE INVENTION

Accordingly, it is an object of the present invention to provide a one-piece drive shaft damper blank that is capable of forming a rolled paper drive shaft damper.

It is a further object of the present invention to provide a one-piece rolled paper drive shaft damper that stays fixed within the drive shaft.

It is a further object of the present invention to provide a one-piece rolled paper drive shaft damper that is formed from a convolutely wound paperboard sheet. Furthermore, the rolled paper drive shaft damper has an adjustable diameter to facilitate placement in a drive shaft.

It is a further object of the present invention to provide a dampened hollow drive shaft, including a hollow drive shaft and a substantially cylindrical convolutely wound paperboard tube positioned within the drive shaft.

It is a further object of the present invention to provide improved methods of forming and inserting a rolled paper drive shaft damper into a drive shaft.

The foregoing, as well as other objectives and advantages of the invention and the manner in which the same are accomplished, is further specified within the following detailed description and its accompanying drawings.

### BRIEF DESCRIPTION OF THE DRAWINGS

FIG. 1 is a schematic view depicting the external side of the one-piece drive shaft damper blank.

FIG. 2 is a schematic view depicting the internal side of the one-piece drive shaft damper blank with the first and second frictional areas.

FIG. 3 is a schematic view from one end of the rolled paper drive shaft damper.

FIG. 4a is a schematic view depicting the rolled paper drive shaft damper.

FIG. 4b is a schematic view depicting the tightly wound rolled paper drive shaft damper.

FIG. 4c is a schematic view depicting the insertion of the tightly wound rolled paper drive shaft damper into a double-swaged drive shaft.

FIG. 4d is a schematic view depicting the hollow drive shaft with the wound rolled paper drive shaft damper inside.

FIG. 4e is a schematic view depicting the dampened hollow drive shaft with the rolled paper drive shaft damper in place.

### DETAILED DESCRIPTION

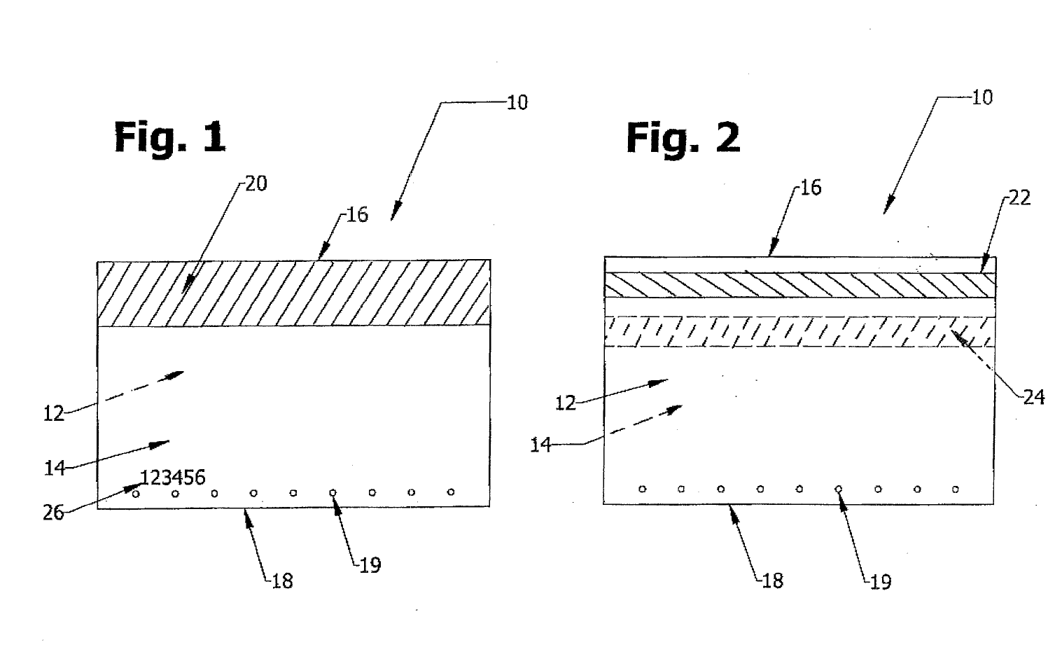

The invention is a one-piece drive shaft damper blank that is capable of forming a rolled paper drive shaft damper for use in a drive shaft tube. The invention also provides a dampened, hollow drive shaft having a substantially cylindrical, convolutely wound paperboard tube positioned therein. In addition, the invention provides methods of making one-piece drive shaft dampers and dampened, hollow drive shafts. These aspects of the present invention are depicted in FIGS. 1-4.

As noted, in one aspect, the invention is a one-piece drive shaft damper blank that is capable of forming a rolled paper drive shaft damper for use in a drive shaft tube.

The drive shaft damper blank 10 is typically formed from a single paperboard sheet such that the damper blank 10 has a one-piece construction. With respect to the damper blank 10, the preferred paperboard has a thickness of between about 5 and 50 mils, preferably between about 20 and 40 mils thick.

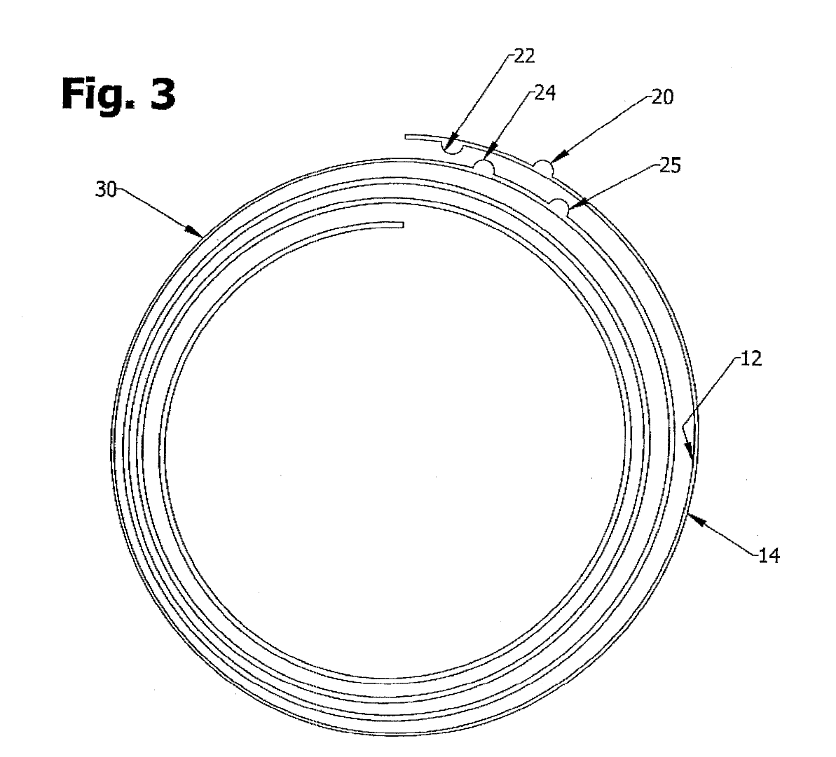

The damper blank 10 further defines an internal planar side 12, an external planar side 14, a top 16, and a bottom 18. FIG. 1 depicts the external planar side 14 of the damper blank 10 and FIG. 2 depicts its internal planar side.

In a typical embodiment, the damper blank 10 of the present invention is substantially rectangular. The damper blank 10, however, need not be limited to any specific shape. For example, the damper blank 10 may be substantially trapezoidal-shaped or substantially parallelogram-shaped.

The damper blank 10 may further include various performance-enhancing properties in accordance with its intended use (i.e., as a rolled paper drive shaft damper 30). See FIGS. 1 to 3. For example, the damper blank 10 may include antioxidants to prevent the damper blank 10 from oxidizing and disintegrating.

Alternatively, the damper blank 10 may be impregnated with antioxidant additives or may be coated with an antioxidant coating.

Further, in accordance with the intended use of the invention, the damper blank 10 may include a part number indicator 26 to facilitate purchasing, storing, installing, and replacing the damper blank 10. In addition, the bottom 18 of the damper blank 10 may include a plurality of openings 19 (i.e., winding apertures) to aid in winding the damper blank 10 into a rolled paper drive shaft damper 30.

In a typical embodiment, the damper blank 10 is formed from fibrous paperboard. To enhance the moisture resistance of the blank 10 (and thus the moisture resistance of the rolled paper drive shaft damper 30), the paperboard sheet can be formed from parchment paper. Parchment paper is known to those of ordinary skill in the art as a grease-resistant and moisture-resistant paper. Alternatively, the moisture resistance of the rolled paper drive shaft damper 30 may be enhanced by coating the paper with silicone.

In a typical embodiment, a frictional coating 20 is applied to the external planar side 14 of the damper blank 10. The frictional coating 20 is positioned such that the distance of the frictional coating 20 from the top of the damper blank 10 is less than the inside circumference of the drive shaft tube (i.e., the product of pi and the inner diameter of the drive shaft tube). In other words, the frictional coating 20 must be positioned less than one drive shaft inner circumference from the top of the damper blank 10. In this manner, the frictional coating 20 will engage the drive shaft tube interior wall 44 and hold the rolled paper drive shaft damper 30 in place.

Suitable frictional coatings include adhesives, such as thermoset adhesives. Thermoset adhesives are applicable if the rolled drive shaft damper 30 is installed into the drive shaft 40 prior to “aging” the drive shaft. Drive shaft aging is part of a finishing process that some drive shaft manufacturers use. Briefly, drive shaft aging includes heating the drive shaft to about 160° C. for four hours. Appropriate adhesives are known to those of ordinary skill in the art.

Polyurethane adhesives are also a suitable frictional coating. Polyurethane adhesives are well known in the industry and appropriate polyurethane derivatives are known to those of ordinary skill in the art.

A preferred frictional coating 20 is latex. Latex has a tacky texture for engaging the drive shaft tube interior wall 44 upon installation of the rolled paper drive shaft damper 30. In addition, latex is not overly sticky such that the paperboard blanks 10 cannot be stacked if latex is applied to the paperboard blanks 10 prior to rolling the paperboard blanks 10 into drive shaft dampers 30.

In another embodiment, the invention is a one-piece drive shaft damper blank 10 that is capable of forming a rolled paper drive shaft damper 30. The damper blank 10 defines first and second opposing surfaces and has a thickness of between about 5 and 50 mils. Preferably, a first frictional area 22 is placed on the first surface and a second frictional area 24 is placed on the second surface.

The damper blank 10 of the present invention may further include a first frictional area 22 on the first surface (i.e., the internal planar side as depicted in FIG. 2) of the damper blank 10 and a second frictional area 24 on the second surface (i.e., the external planar side as depicted in FIG. 2) of the damper blank 10. Similar to the above-mentioned frictional coating 20, the frictional areas 22,24 are preferably latex but may also be formed from adhesives.

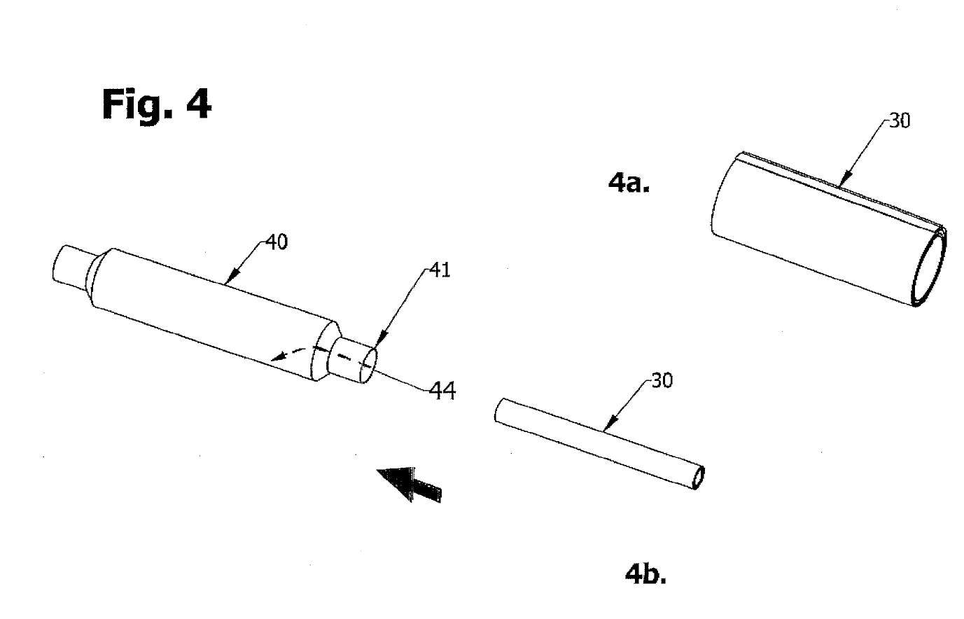

In a preferred embodiment, the first and second frictional areas 22,24 correspond when the damper blank 10 is formed into a convolutely wound paperboard tube 30. See FIG. 3. Latex is preferred in this application for the frictional areas 22,24 because latex possesses self-engaging properties (i.e., latex possesses desirable self-adhering properties). In this manner, the frictional areas 22,24 will engage and maintain the position (i.e., diameter) of the rolled paper drive shaft damper 30 within a hollow, substantially cylindrical driveshaft 40. See FIG. 3. The use of other self-engaging compositions in this manner is within the scope of the present invention. In this regard, such self-adhering compositions are within the knowledge of those having ordinary skill in the art.

Specifically, placement of the first and second frictional areas 22,24 is as follows. The first frictional area 22 is placed on the first surface 12 at a distance (x) from the top 16 of the damper blank 10. The second frictional area 24 is positioned on the second surface 14 at a distance equal to one circumference away from (x) based on the expected circumference of the rolled paper drive shaft damper 30. Accordingly, the first and second frictional areas 22, 24 will correspond to the same latitude of the damper blank 10 (i.e., corresponding side to side position) such that the frictional areas 22, 24 engage and maintain the structural integrity of the rolled paper drive shaft damper 30. In other words, the desired diameter becomes fixed.

In addition, the drive shaft damper blank 10 of the present invention may include supplemental frictional areas 25 on the second surface of the damper blank 10. The supplemental frictional areas 25 serve to maintain the position of the rolled paper drive shaft damper 30 within the drive shaft 40 after any adjustment in the diameter of the drive shaft damper 30.

The drive shaft damper blank 10 according to the present invention may be germane to non-automotive applications. For instance, the present drive shaft damper blank 10 may be employed as described or with appropriate modification to mitigate NVH in prop shafts (e.g., watercraft, aircraft, stationary gas turbines, and turbines generally) or even in fixed tubing (e.g., ductwork or support columns).

In another aspect, the invention is a substantially cylindrical rolled paper drive shaft damper 30 having an adjustable diameter.

Typically, the rolled paper drive shaft damper 30 is a convolutely wound paperboard tube formed from a single paperboard blank 10. The paperboard tube 30 has an overall wall thickness of between about 10 and 200 mils, preferably between about 15 and 150 mils, and more preferably between about 30 and 120 mils. In one embodiment, the substantially cylindrical rolled paper drive shaft damper 30 has three complete plies. See FIG. 3.

The paperboard tube 30 defines an inside surface 12 and an outside surface 14, which correspond to the internal and external planar sides 12,14 of the damper blank 10, respectively. With respect to the damper blank 10 of the invention, the outside surface 14 of the convolutely wound paperboard tube 30 has a frictional coating 20. Preferably, the frictional coating 20 is latex (e.g., in the form of a daub or an applied axial strip). Other suitable materials for the frictional coating 20 include polyurethane and adhesives, such as thermoset adhesives.

In addition to the frictional coating 20, the outside surface 14 of the paperboard tube 30 may be textured to further facilitate substantial contact with the drive shaft tube interior wall 44. For instance, the outside surface 14 may be smooth to maximize contact surface area or slightly bumpy to discourage slippage. The textured outside surface 14 will serve to prevent unwanted movement of the drive shaft damper 30 within the drive shaft 40.

The paperboard tube 30 of the present invention also benefits from the above-mentioned performance-enhancing properties of the damper blank 10. The paperboard tube 30 may include antioxidants (e.g., antioxidant additives, impregnation with antioxidants, antioxidant coatings, and antioxidant treatment on the outside surface 14). A further performance-enhancing property includes the use of parchment paper or silicone-coated paper for increased moisture resistance.

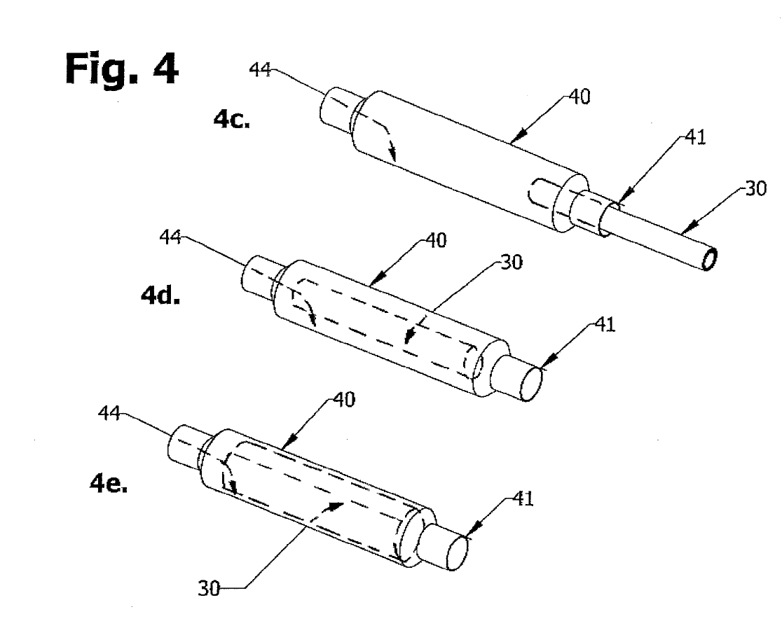

The convolutely wound paperboard tube 30 has an adjustable diameter to facilitate placement of the paperboard tube 30 within a drive shaft 40. See FIGS. 4a to 4e. This facilitates placement in a hollow double-swaged drive shaft 40.

To illustrate, the paperboard tube 30 may be wound to a diameter smaller than the drive shaft tube opening 41. See FIGS. 4a and 4b. Thereafter, the rolled paper drive shaft damper 30 is inserted into the drive shaft tube opening 41 and increases its diameter to further facilitate final placement within and substantially contact the drive shaft tube interior wall 44. See FIGS. 4c to 4e. Thus, the rolled paper drive shaft damper 30 adjusts its diameter to facilitate placement within a double-swaged drive shaft 40.

For example, the drive shaft damper 30 diameter (represented by d_{d}) is equal to, or preferably slightly less than, the drive shaft tube 40 diameter (represented by Dₜ). Therefore, the drive shaft damper 30 of the present invention adjusts its diameter such that d_{d}≦Dₜ for any given Dₜ.

In addition, the convolutely wound nature of the drive shaft damper 30 further allows the diameter of the drive shaft damper 30 to increase without reducing axial coverage within the hollow drive shaft 40. This allows substantially complete contact of the drive shaft damper 30 with the drive shaft tube interior wall 44.

Those having ordinary skill in the art will appreciate that paperboard carries a “grain orientation.” Grain orientation refers to paper's fiber alignment, which is established during the papermaking process (i.e., the paper's formation on the paper machine). In this regard, the term “machine direction” (i.e., MD) describes the predominant direction of fiber alignment. In contrast, the term “cross direction” (i.e., CD) describes the direction of fiber alignment that is perpendicular to machine direction.

The convolutely wound paperboard tube 30 of the present invention may be wound in either the machine direction or the cross direction with respect to the paper fibers. The grain orientation determines, in part, the “stiffness” of the paperboard. For example, paperboard tubes made from cylinder board will be stiffer in the machine direction compared with the cross direction. Thus, if easy-to-wind paperboard tubes are desired, the paperboard may be wound in the cross-direction. Conversely, if paperboard tubes having greater expansion strength are desired, the paperboard may be wound in the machine direction.

In yet another aspect, the invention is a dampened hollow drive shaft including the above-described damper blank 10 and convolutely wound rolled paper drive shaft damper 30 of the present invention inserted into a hollow drive shaft 40. The convolutely wound rolled paper drive shaft damper 30 of the present invention is especially suited for double-swaged drive shafts. See FIGS. 4b to 4e.

In accordance with the damper blank 10 and convolutely wound rolled paper drive shaft damper 30 of the present invention, the convolutely wound paperboard tube 30 positioned within the dampened hollow drive shaft 40 includes all of the above-mentioned features. The result is a dampened hollow drive shaft 40 having reduced or eliminated NVH. Furthermore, the frictional area 20 on the outside surface 14 of the rolled paper drive shaft damper 30 engages the drive shaft tube interior wall 44 such that the drive shaft damper 30 will not move once placed inside the drive shaft 40.

In yet another aspect, the invention is a method of making a rolled paper drive shaft damper. The method includes rolling a damper blank into a convolutely wound, substantially cylindrical tube having at least about two full plies. The method further includes inserting the substantially cylindrical tube into a hollow double-swaged drive shaft. Alternatively, the method includes maintaining the substantially cylindrical tube in convolute form.

Rolling the damper blank into a convolutely wound tube is typically performed using a rotary device (e.g., a hand drill, a hand-held manual device, a slotted mandrel, or the like). Accordingly, the damper blank must be connected to the rotary device and the convolutely wound tube must be disconnected from the rotary device.

With respect to the drive shaft damper blank and the rolled paper drive shaft damper of the invention, the damper blank may be connected to the rotary device using an adhesive. Appropriate adhesives are known to those of ordinary skill in the art.

Connecting the paper drive shaft damper blank to the rotary device may also be accomplished using the above-mentioned winding apertures. See FIGS. 1 and 2. In accordance with the drive shaft damper blank of the invention, the winding apertures are preferably located at the bottom of the damper blank.

The rolled paper drive shaft damper may be inserted into the drive shaft immediately following its formation or maintained in its convolutely wound form for transportation and storage. Maintaining the drive shaft damper in its convolutely wound form is useful, for example, if the drive shaft dampers will be installed in the drive shafts at a separate location.

The convolutely wound tube may be maintained in substantially cylindrical form using rubber bands radially surrounding the drive shaft damper. The rubber band will maintain the tube in cylindrical form until it is removed. Alternatively, the convolutely wound tube may be maintained in substantially cylindrical form using adhesive tabs securing the outermost ply of the rolled paper drive shaft damper to itself or secured to an inner ply. In another embodiment, adhesive tabs may secure the outermost ply of the rolled paper drive shaft damper to itself and further secure a pull cord. Upon insertion of the rolled paper drive shaft damper into the drive shaft, pulling the pull cord will break the adhesive bond securing the outermost ply, allowing the rolled paper drive shaft damper to radially expand within the drive shaft.

Inserting the cylindrical tube into the drive shaft may be performed before or after the step of disconnecting the tube from the rotary device. Furthermore, the step of actively unwinding the cylindrical tube within the hollow drive shaft may be performed prior to disconnecting the tube from the rotary device.

In still another aspect, the invention is a method for inserting a rolled paper drive shaft damper into a drive shaft. The method includes the damper blank, the rolled paper drive shaft damper, and the substantially cylindrical drive shaft previously discussed. In a preferred embodiment, the internal and external planar sides each include a frictional area.

The method of the invention further includes the steps of convolutely rolling the drive shaft damper blank into a substantially cylindrical tube, inserting the tube into a hollow drive shaft, and radially expanding the tube to substantially conform to the drive shaft tube interior wall. The method necessitates rolling the drive shaft damper blank such that its outer diameter is smaller than the inner diameter of the drive shaft.

The convolutely wound cylindrical tube is especially suited for double-swaged drive shafts. In this regard, convolutely rolling the drive shaft damper blank may be accomplished manually or automatically using the above-mentioned rotary device. Accordingly, inserting the cylindrical tube into the drive shaft may be performed manually or automatically.

Radially expanding the tube includes unwinding the tube to ensure that the tube completely engages the drive shaft tube interior wall. Typically, unwinding the tube may be performed using one of the above-mentioned rotary devices.

In a preferred embodiment, the frictional areas on the external and internal planar sides are placed such that the frictional areas will correspond and engage upon convolutely rolling the drive shaft damper blank into a cylindrical tube. In other words, the internal planar side frictional area is placed one revolution past the external planar side frictional area relative to the circumference of the substantially cylindrical tube. Unwinding the tube engages the frictional areas and maintains the diameter of the cylindrical tube.

In the specification and drawings, there have been disclosed typical embodiments of the invention and, although specific terms have been employed, they have been used in a generic and descriptive sense only and not for purposes of limitation, the scope of the invention being set forth in the following claims.

1. A rolled paper drive shaft damper, comprising:
a substantially cylindrical convolutely wound paperboard tube formed from a single paperboard blank, said tube having an overall wall thickness between about 10 and 200 mils, said tube defining an inside surface and an outside surface; and
a frictional coating on the outside surface of said convolutely wound paperboard tube; and
wherein said convolutely wound paperboard tube has an adjustable diameter to facilitate placement in a hollow drive shaft.

2. The rolled paper drive shaft damper according to claim 1, wherein said tube has an overall wall thickness of between about 15 and 150 mils.

3. The rolled paper drive shaft damper according to claim 1, wherein said tube has an overall wall thickness of between about 30 and 120 mils.

4. The rolled paper drive shaft damper according to claim 1, wherein said convolutely wound paperboard tube is wound in the machine direction with respect to the paper fibers.

5. The rolled paper drive shaft damper according to claim 1, wherein said convolutely wound paperboard tube is wound in the cross direction with respect to the paper fibers.

6. The rolled paper drive shaft damper according to claim 1, wherein said paperboard tube comprises antioxidants.

7. The rolled paper drive shaft damper according to claim 1, wherein said paperboard tube either comprises an antioxidant coating or is impregnated with antioxidant additives.

8. The rolled paper drive shaft damper according to claim 1, wherein said outside surface is treated with an antioxidant.

9. The rolled paper drive shaft damper according to claim 1, wherein said outside surface is textured whereby said outside surface of said convolutely wound paperboard tube achieves substantial contact with the drive shaft tube interior wall.

10. The rolled paper drive shaft damper according to claim 1, wherein said frictional coating comprises latex.

11. The rolled paper drive shaft damper according to claim 1, wherein said frictional coating comprises an applied axial strip of latex, polyurethane, or both.

12. The rolled paper drive shaft damper according to claim 1, wherein said frictional coating comprises an adhesive.

13. The rolled paper drive shaft damper according to claim 12, wherein said frictional coating comprises a thermoset adhesive.

14. The rolled paper drive shaft damper according to claim 1, wherein said paperboard sheet comprises parchment paper or silicone-coated paper.

15. The rolled paper drive shaft damper according to claim 1, wherein substantial contact with the drive shaft tube interior wall comprises complete contact with the drive shaft tube interior wall.

16. The rolled paper drive shaft damper according to claim 1, wherein said adjustable diameter comprises decreasing the diameter to facilitate placement in a hollow double-swaged drive shaft.

17. The rolled paper drive shaft damper according to claim 1, wherein said adjustable diameter comprises increasing the diameter to facilitate placement in and substantial contact with the drive shaft tube interior wall.

18. A rolled paper drive shaft damper, comprising:
a substantially cylindrical paperboard tube having three complete plies formed from a single paperboard blank, said tube defining an inside surface and an outside surface; and
a frictional coating on the outside surface of said tube; and
wherein, upon placement of said tube within a hollow drive shaft, said tube diameter is adjustable within the hollow drive shaft without reducing axial coverage within the hollow drive shaft.

19. The rolled paper drive shaft damper according to claim 18, wherein said tube has a wall thickness of between about 10 and 200 mils.

20. The rolled paper drive shaft damper according to claim 18, wherein said tube has a wall thickness of between about 30 and 120 mils.

21. The rolled paper drive shaft damper according to claim 18, wherein said paperboard sheet comprises parchment paper or silicone-coated paper.

22. The rolled paper drive shaft damper according to claim 18, wherein said tube comprises antioxidants.

23. The rolled paper drive shaft damper according to claim 18, wherein said frictional coating comprises latex.

24. The rolled paper drive shaft damper according to claim 18, wherein said frictional coating comprises an applied axial strip of latex.

25. The rolled paper drive shaft damper according to claim 18, wherein said frictional coating comprises an applied axial strip of polyurethane.

26. The rolled paper drive shaft damper according to claim 18, wherein said frictional coating comprises an adhesive.

27. The rolled paper drive shaft damper according to claim 18, wherein said adjustable tube diameter comprises decreasing the diameter to facilitate insertion into the drive shaft.

28. The rolled paper drive shaft damper according to claim 18, wherein said adjustable tube diameter comprises increasing the diameter to engage the drive shaft tube interior wall.

29. A method of making a rolled paper drive shaft damper, comprising:
a. connecting a paper drive shaft damper blank to an automated rolling means;
b. actuating the rolling means to form the blank into a convolutely wound, substantially cylindrical tube having at least about two full plies;
c. maintaining the substantially cylindrical tube in convolute form using an attachment means; and
d. disconnecting the substantially cylindrical tube from the rolling means.

30. The method according to claim 29, wherein the connecting step further comprises connecting the paper drive shaft damper blank to an automated rolling means via adhesive.

31. The method according to claim 29, wherein the connecting step further comprises connecting the paper drive shaft damper blank to an automated rolling means via winding apertures.

32. The method according to claim 29, wherein the rolling means is a rotary device.

33. The method according to claim 29, wherein the attachment means comprises a rubber band radially surrounding the rolled paper drive shaft damper.

34. The method according to claim 29, wherein the attachment means comprises adhesive tabs securing the outermost ply of the rolled paper drive shaft damper.

35. The method according to claim 29, wherein the attachment means comprises adhesive tabs securing the outermost ply of the rolled paper drive shaft damper to an inner ply.

36. The method according to claim 29, wherein:
the attachment means comprises adhesive tabs securing the outermost ply of the rolled paper drive shaft damper; and
the adhesive tabs further secure a pull cord that will break the adhesive bond between the plies when pulled and allow the rolled paper drive shaft damper to radially expand.
